(19) United States
(12) Patent Application Publication
(10) Pub. No.: US 2013/0007142 A1
(43) Pub. Date: Jan. 3, 2013

(54) Processing A Message

(76) Inventor: Jonathan Rosenberg, Freehold, NJ (US)

(21) Appl. No.: 13/173,590

(22) Filed: Jun. 30, 2011

(51) Int. Cl. G06F 15/16

(52) U.S. Cl. 709/206

(57) ABSTRACT

A method of processing a message for communication from a sender user terminal of a sender in a first time zone to a recipient user terminal of a recipient in a second time zone, the method comprising: receiving, at the sender user terminal from the sender, content of the message; determining that the content includes an indication of a time in the first time zone; sending the message over a network from the sender user terminal to the recipient user terminal; determining a corresponding time in the second time zone which corresponds to the time in the first time zone indicated by the indication; and conveying the message to the recipient at the recipient user terminal, the conveyed message including a second indication which indicates the determined corresponding time in the second time zone.

### FIELD OF THE INVENTION

The present invention relates to processing a message. In particular the present invention relates to processing a message for communication from a sender user terminal of a sender in a first time zone to a recipient user terminal of a recipient in a second time zone.

### BACKGROUND

Messages can be sent between users using a number of different communication systems. For example, text-based messages (i.e. messages which have text content) can be sent as emails, instant messages or SMS messages between users, using a network such as the Internet or the Public Switched Telephone Network (PSTN). Other messages may be voice messages or multimedia messages.

Messages can be sent over very large distances in very short time scales. In particular, messages can be sent between users who are in different time zones e.g. over the internet or over the PSTN. It may be that a sender is not aware of the location, or time zone, of the recipient of a message when the message is sent to the recipient. This can make it difficult for the sender to express a time to the recipient correctly. Furthermore, there may be a number of recipients for a message and the different recipients may be located in different time zones, which again makes it difficult for the sender of the message to correctly identify a time to the recipients in such a way that all of the recipients will correctly understand the time.

As an example, text-based instant messages may be used frequently for many types of conversations, with one important application being within a business (i.e. between users of a business). Instant messages have become a useful tool for communications, filling a need in between email and telephony. One common usage for instant messaging is for the planning of meetings. One or more users can “chat”, i.e. exchange instant messages, about their availability for a meeting or telephone call (or any other event in which the users are to simultaneously participate), allowing the users to interactively determine a time for the event which is convenient for all of the users. However, a common problem where the users are in different time zones is that a sender in the chat will propose a time for an event (e.g. by sending a message saying “how about 3 pm?”) but will omit a time zone. The recipient of the message may not know what time zone the sender is in, leading to confusion about the proposed time. Another problem is that even if the sender does include the time zone (e.g. by sending a message saying “how about 3 pm PST”), the recipient might not be sure how to convert the time to their local time zone.

FIG. 1 is an example of an instant messaging exchange between a sender user (who is called “Mary” in the example shown in FIG. 1) and a recipient user (who is called “Bob” in the example shown in FIG. 1). The user interface 102 is shown to Mary at Mary's user terminal, while the user interface 112 is shown to Bob at Bob's user terminal. Mary is in California and Bob is in London in the example shown in FIG. 1. The user interface 102 includes a pane 104 which shows the messages which have been sent in the instant messaging communication so far. The user interface 102 also includes a pane 106 to allow Mary to enter content for a new instant message to be sent to Bob. The user interface 102 also includes a button 108, which if actuated by Mary (e.g. by clicking on the button 108 with a mouse) will cause an instant message, including the content that has been entered into the pane 106, to be sent to Bob's user terminal. Similarly, Bob's user interface 112 includes a pane 114 which shows the messages which have been sent in the instant messaging communication so far. The user interface 112 also includes a pane 116 to allow Bob to enter content for a new instant message to be sent to Mary. The user interface 112 also includes a button 118, which if actuated by Bob (e.g. by clicking on the button 118 with a mouse) will cause an instant message, including the content that has been entered into the pane 116, to be sent to Mary's user terminal.

It can be seen in the conversation shown in FIG. 1 that there is some confusion over what Mary means when she says “how about 3?” Bob is not sure whether Mary means 3 o'clock in her time zone (i.e. in California's time zone) or in Bob's time zone (i.e. in London's time zone). Even once Mary and Bob have established that Mary had meant the time to be in California's time zone, there is still some confusion as to how to translate this time into a corresponding time in Bob's time zone. Indeed, it can be seen that initially they get the time difference between Mary and Bob's time zones wrong, and only after multiple messages is the correct time of 11 pm in Bob's time zone established.

### SUMMARY

The inventor has realised that, in the prior art, when users in different time zones send messages to each other, where the messages include, in their content, indications of times in one or other of the time zones, there can be significant confusion as to exactly what time is being referring to. This leads to problems in setting up meetings (and other events in which the users are to simultaneously participate) between the users. A significant amount of time can be wasted in the prior art systems (e.g. as shown in FIG. 1) in order to address the confusion caused by the difference in time zones between the users when messages are sent which include indications of times.

According to a first aspect of the invention there is provided a method of processing a message for communication from a sender user terminal of a sender in a first time zone to a recipient user terminal of a recipient in a second time zone, the method comprising: receiving, at the sender user terminal from the sender, content of the message; determining that the content includes an indication of a time in the first time zone; sending the message over a network from the sender user terminal to the recipient user terminal; determining a corresponding time in the second time zone which corresponds to the time in the first time zone indicated by the indication; and conveying the message to the recipient at the recipient user terminal, the conveyed message including a second indication which indicates the determined corresponding time in the second time zone.

In preferred embodiments, when the content of a message includes an indication of a time in the first time zone, a corresponding time is determined in the second time zone and an indication of that corresponding time is included in the message which is conveyed to the recipient. In this way the recipient is presented with an indication of a time in his own time zone. This prevents confusion as to the time to which the indication is referring.

In further embodiments the content may comprise text. The message may be an email message or an instant message.

The content may comprise voice data.

The time indicated by the indication may be a time for an event in which the sender and the recipient are to simultaneously participate.

Said determining a corresponding time in the second time zone may comprise: determining the first time zone of the sender; determining the second time zone of the recipient; and using the determined first and second time zones and the indication of the time in the first time zone to determine the corresponding time in the second time zone.

The step of sending the message over a network from the sender user terminal to the recipient user terminal may comprise sending the message via a server, and wherein the step of determining a corresponding time in the second time zone may be performed by the server.

Said determining a corresponding time in the second time zone may comprise: determining the first time zone of the sender; using the determined first time zone to determine a standardised time in a predetermined time zone which corresponds to the time in the first time zone indicated by the indication; determining the second time zone of the recipient; and using the determined second time zone and the determined standardised time in the predetermined time zone to determine the corresponding time in the second time zone.

The steps of determining the first time zone and using the determined first time zone to determine a standardised time may be performed at the sender user terminal, and wherein the steps of determining the second time zone using the determined second time zone and the determined standardised time in the predetermined time zone to determine the corresponding time may be performed at the recipient user terminal.

The step of sending the message over a network from the sender user terminal to the recipient user terminal may comprise sending the message over a point-to-point route between the sender user terminal and the recipient user terminal.

There may be a plurality of recipient user terminals of a respective plurality of recipients of the message.

According to another aspect of the present invention, there is provided a communication system comprising a sender user terminal of a sender in a first time zone and a recipient user terminal of a recipient in a second time zone, the communication system comprising: a receiver configured to receive, at the sender user terminal from the sender, content of a message; a content determining module configured to determine that the content includes an indication of a time in the first time zone; a sending module configured to send the message over a network from the sender user terminal to the recipient user terminal; at least one time determining module configured to determine a corresponding time in the second time zone which corresponds to the time in the first time zone indicated by the indication; and a conveying module configured to convey the message to the recipient at the recipient user terminal, the conveyed message including a second indication which indicates the determined corresponding time in the second time zone.

In embodiments the system may further comprise a server, wherein the message may be sent from the sender user terminal to the recipient user terminal via the server.

The receiver and the content determining module may be implemented at the sender user terminal, wherein the at least one time determining module may be implemented at the server and wherein the conveying module may be implemented at the recipient user terminal.

The receiver and the content determining module may be implemented at the sender user terminal, wherein the conveying module may be implemented at the recipient user terminal, and wherein the at least one time determining module may comprise a first time determining module implemented at the sender user terminal and second time determining module implemented at the recipient user terminal.

According to another aspect of the present invention, there is provided a method of sending a message over a network from a sender user terminal of a sender in a first time zone to a recipient user terminal of a recipient in a second time zone, the method comprising: receiving, at the sender user terminal from the sender, content of the message; determining, at the sender user terminal, that the content includes an indication of a time in the first time zone; determining, at the sender user terminal, the first time zone of the sender; determining, at the sender user terminal, a standardised time in a predetermined time zone which corresponds to the time in the first time zone indicated by the indication; including the standardised time in the message; and sending the message over the network from the sender user terminal to the recipient user terminal, such that by using the standardised time in the message and the second time zone the recipient user terminal can determine a corresponding time in the second time zone which corresponds to the time in the first time zone indicated by the indication.

According to another aspect of the present invention there is provided a computer program product comprising computer readable instructions for execution by computer processing means at a sender user terminal of a sender in a first time zone for sending a message over a network from the sender user terminal to a recipient user terminal of a recipient in a second time zone, the instructions comprising instructions for carrying out the above method.

According to another aspect of the present invention, there is provided a sender user terminal of a sender in a first time zone for sending a message over a network to a recipient user terminal of a recipient in a second time zone, the sender user terminal comprising: a receiver configured to receive, from the sender, content of the message; a content determining module configured to determine that the content includes an indication of a time in the first time zone; a first time zone determining module configured to determine the first time zone of the sender; a standardised time determining module configured to determine a standardised time in a predetermined time zone which corresponds to the time in the first time zone indicated by the indication; a processing module configured to include the standardised time in the message; and a sending module configured to send the message over the network to the recipient user terminal, such that by using the standardised time in the message and the second time zone the recipient user terminal can determine a corresponding time in the second time zone which corresponds to the time in the first time zone indicated by the indication.

According to another aspect of the present invention, there is provided a message received, from a sender user terminal of a sender in a first time zone, at a recipient user terminal of a recipient in a second time zone, the method comprising: receiving a message at the recipient user terminal over a network from the sender user terminal, the message comprising a standardised time in a predetermined time zone; determining, at the recipient user terminal, the second time zone of the recipient; using the determined second time zone and the standardised time in the predetermined time zone to determine, at the recipient user terminal, a corresponding time in the second time zone which corresponds to the standardised time in the predetermined time zone; and conveying the message to the recipient at the recipient user terminal, the conveyed message including an indication which indicates the determined corresponding time in the second time zone.

According to another aspect of the present invention, there is provided a computer program product comprising computer readable instructions for execution by computer processing means at a recipient user terminal for processing a message received from a sender user terminal of a sender in a first time zone, the recipient user terminal being of a recipient in a second time zone, the instructions comprising instructions for carrying out the method according to the above method.

According to another aspect of the present invention there is provided a recipient user terminal for processing a message received from a sender user terminal of a sender in a first time zone, the recipient user terminal being of a recipient in a second time zone, the recipient user terminal comprising: a receiver configured to receive a message over a network from the sender user terminal, the message comprising a standardised time in a predetermined time zone; a time zone determining module configured to determine the second time zone of the recipient; a time determining module configured to determine a corresponding time using the determined second time zone and the standardised time in the predetermined time zone, the corresponding time being a time in the second time zone which corresponds to the standardised time in the predetermined time zone; and a conveying module configured to convey the message to the recipient at the recipient user terminal, the conveyed message including an indication which indicates the determined corresponding time in the second time zone.

According to another aspect of the present invention, there is provided a method of processing a message at a server, the message being for communication from a sender user terminal of a sender in a first time zone to a recipient user terminal of a recipient in a second time zone, the method comprising: receiving the message at the server from the sender user terminal over a network; determining, at the server, that the content of the message includes an indication of a time in the first time zone; determining, at the server, a corresponding time in the second time zone which corresponds to the time in the first time zone indicated by the indication; and transmitting the message from the server to the recipient user terminal over the network, the transmitted message including a second indication which indicates the determined corresponding time in the second time zone.

According to another aspect of the present invention, there is provided a computer program product comprising computer readable instructions for execution by computer processing means at a server for processing a message, the message being for communication from a sender user terminal of a sender in a first time zone to a recipient user terminal of a recipient in a second time zone, the instructions comprising instructions for carrying out the method according to the above method.

According to another aspect of the present invention, there is provided a server for processing a message, the message being for communication from a sender user terminal of a sender in a first time zone to a recipient user terminal of a recipient in a second time zone, the server comprising: a receiver configured to receive the message from the sender user terminal over a network; a content determining module configured to determine that the content of the message includes an indication of a time in the first time zone; a time determining module configured to determine a corresponding time in the second time zone which corresponds to the time in the first time zone indicated by the indication; and a transmitter configured to transmit the message to the recipient user terminal over the network, the transmitted message including a second indication which indicates the determined corresponding time in the second time zone.

### BRIEF DESCRIPTION OF THE DRAWINGS

For a better understanding of the present invention and to show how the same may be put into effect, reference will now be made, by way of example, to the following drawings in which:

FIG. 1 shows an instant messaging exchange between a sender user and a recipient user according to a prior art system;

FIG. 2 shows a communication system according to a preferred embodiment;

FIG. 3 shows a block diagram of a user terminal according to a preferred embodiment;

FIG. 4 is a flow chart for a process of processing a message for communication from a sender user terminal to a recipient user terminal according to a first embodiment;

FIG. 5 shows an instant messaging exchange between a sender user and a recipient user according to a preferred embodiment; and

FIG. 6 is a flow chart for a process of processing a message for communication from a sender user terminal to a recipient user terminal according to a second embodiment.

### DETAILED DESCRIPTION OF PREFERRED EMBODIMENTS

Preferred embodiments of the invention will now be described by way of example only.

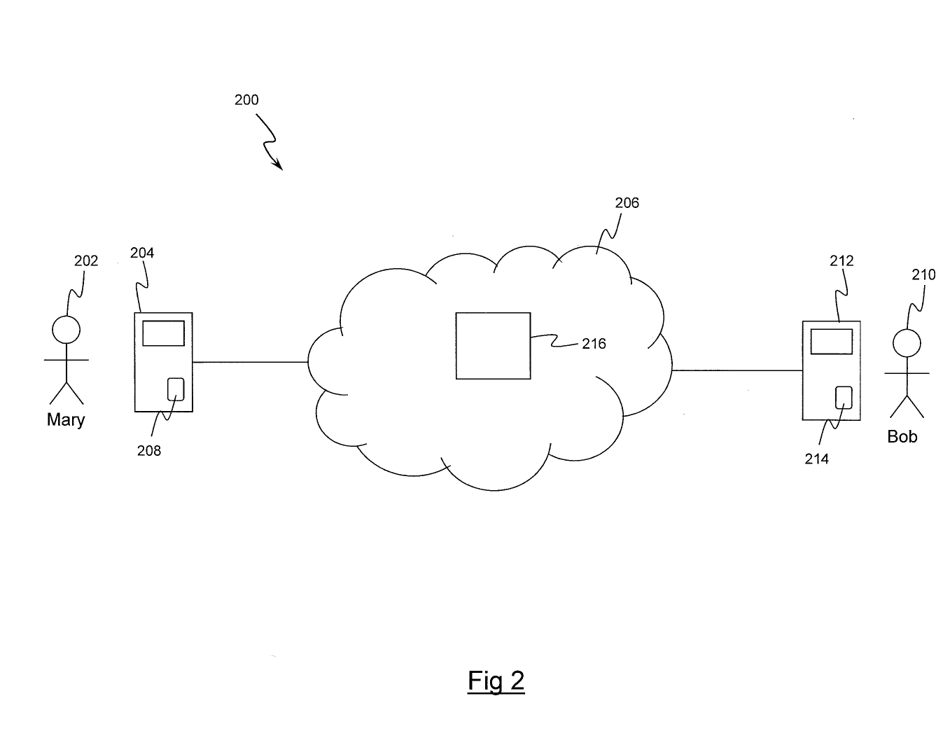

FIG. 2 shows a communication system comprising a first user (“Mary”) 202 who has an associated first user terminal 204 and a second user (“Bob”) 210 who has an associated second user terminal 212. The user terminals 204 and 212 can communicate over the network 206 in the communication system, thereby allowing the users 202 and 210 to communicate with each other over the network 206. In the preferred embodiment the communication system is a packet-based, P2P communication system, but other types of communication system could also be used, such as non-P2P, VoIP or IM systems. The network 206 may, for example, be the Internet or the PSTN. The user terminal 204 may be, for example, a mobile phone, a personal digital assistant (“PDA”), a personal computer (“PC”) (including, for example, Windows™, Mac OS™ and Linux™ PCs), a gaming device or other embedded device able to connect to the network 206. The user terminal 204 is arranged to receive information from and output information to the user 202 of the user terminal 204. In a preferred embodiment of the invention the user terminal 204 comprises a display such as a screen and an input device such as a keyboard, mouse, touch-screen, keypad and/or joystick. The user terminal 204 is connected to the network 206.

Note that in alternative embodiments, the user terminal 204 can connect to the network 206 via additional intermediate networks not shown in FIG. 2. For example, if the user terminal 204 is a mobile device, then it can connect to the network 206 via a cellular mobile network 220 (for example a GSM or UMTS network), not shown in FIG. 2.

The user terminal 204 executes a communication client 208, provided by a software provider associated with the communication system. The communication client 208 is a software program executed on a local processor in the user terminal 204. The client 208 performs the processing required at the user terminal 204 in order for the user terminal 204 to transmit and receive data over the communication system. As is known in the art, the client 208 may be authenticated to communicate over the communication system through the presentation of digital certificates (e.g. to prove that User A 202 is a genuine subscriber of the communication system—described in more detail in WO 2005/009019).

The user terminal 212 corresponds to the user terminal 204. The user terminal 212 executes, on a local processor, a communication client 214 which corresponds to the communication client 208. The client 214 performs the processing required to allow the user 210 to communicate over the network 206 in the same way that the client 208 performs the processing required to allow the user 202 to communicate over the network 206. FIG. 2 shows only two users (202 and 210) for clarity, but many more users may be connected to the communication system, and may communicate over the communication system using respective communication clients executed on respective user terminals, as is known in the art. The communication system includes a server 216 on the network 206.

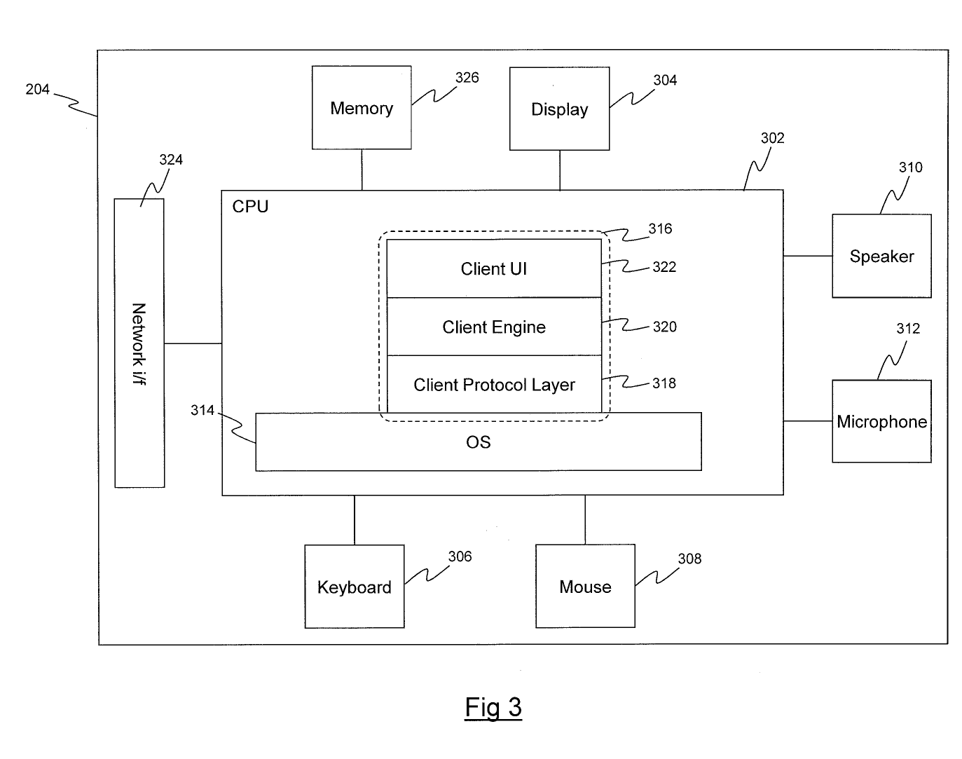

FIG. 3 illustrates a detailed view of the user terminal 204 on which is executed client 208. The user terminal 204 comprises a central processing unit (“CPU”) 302, to which is connected a display 304 such as a screen, input devices such as a keyboard (or a keypad) 306 and a pointing device such as a mouse 308. The display 304 may comprise a touch screen for inputting data to the CPU 302. An output audio device 310 (e.g. a speaker) and an input audio device 312 (e.g. a microphone) are connected to the CPU 302. The display 304, keyboard 306, mouse 308, output audio device 310 and input audio device 312 are integrated into the user terminal 204. In alternative user terminals one or more of the display 304, the keyboard 306, the mouse 308, the output audio device 310 and the input audio device 312 may not be integrated into the user terminal 204 and may be connected to the CPU 302 via respective interfaces. One example of such an interface is a USB interface. The CPU 302 is connected to a network interface 324 such as a modem for communication with the network 206. The network interface 324 may be integrated into the user terminal 204 as shown in FIG. 3. In alternative user terminals the network interface 324 is not integrated into the user terminal 204. The user terminal 204 also comprises a memory 326 for storing data as is known in the art.

FIG. 3 also illustrates an operating system (“OS”) 314 executed on the CPU 302. Running on top of the OS 314 is a software stack 316 for the client 208. The software stack shows a client protocol layer 318, a client engine layer 320 and a client user interface layer (“UI”) 322. Each layer is responsible for specific functions. Because each layer usually communicates with two other layers, they are regarded as being arranged in a stack as shown in FIG. 3. The operating system 314 manages the hardware resources of the computer and handles data being transmitted to and from the network via the network interface 324. The client protocol layer 318 of the client software communicates with the operating system 314 and manages the connections over the communication system. Processes requiring higher level processing are passed to the client engine layer 320. The client engine 320 also communicates with the client user interface layer 322. The client engine 320 may be arranged to control the client user interface layer 322 to present information to the user 202 via the user interface of the client and to receive information from the user 202 via the user interface.

The user terminal 212 is implemented in the same way as user terminal 204 as described above, wherein the user terminal 212 may have corresponding elements to those described herein in relation to user terminal 204.

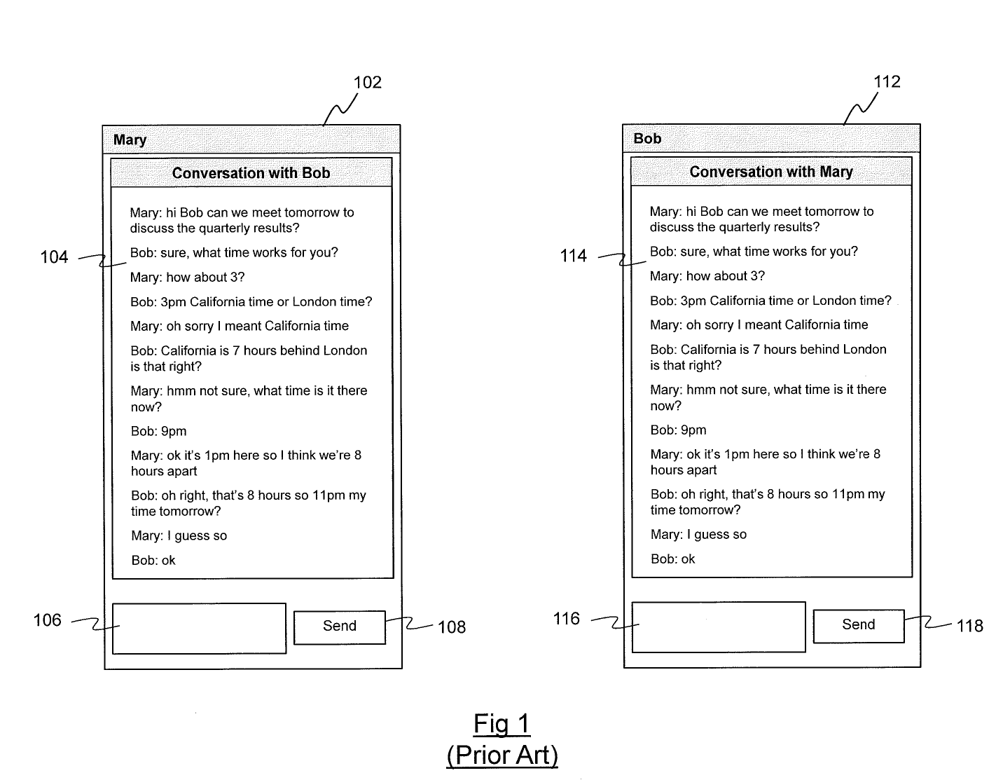

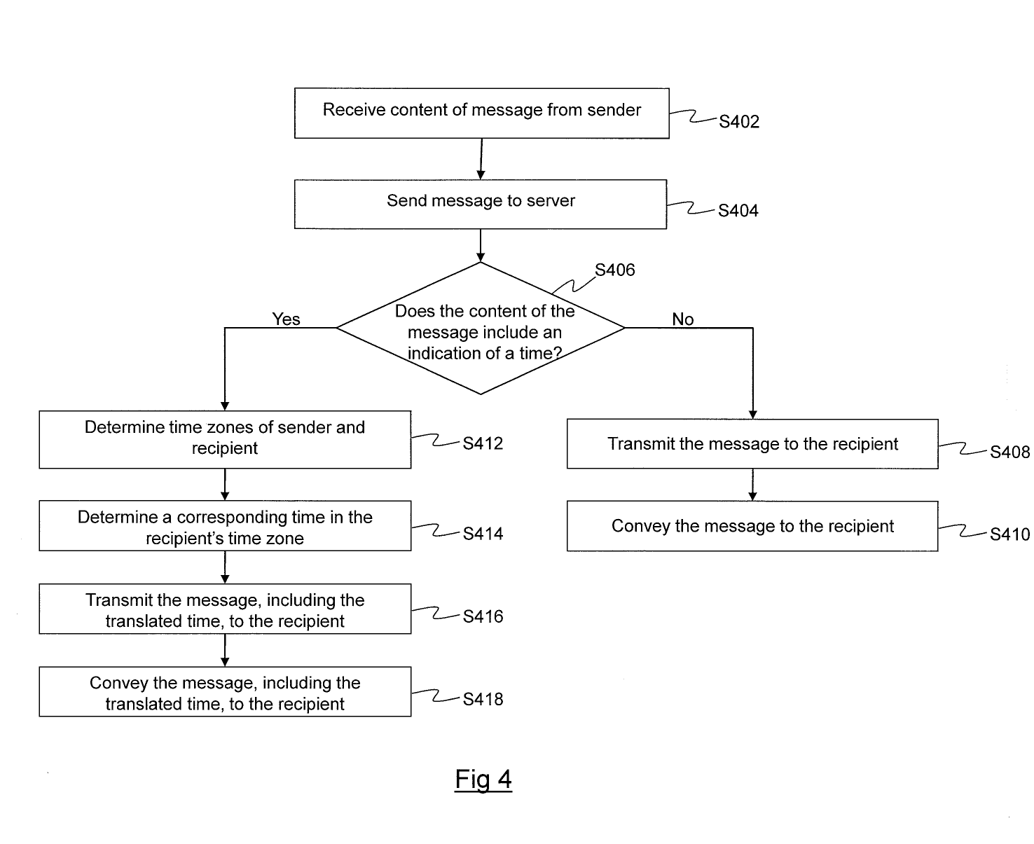

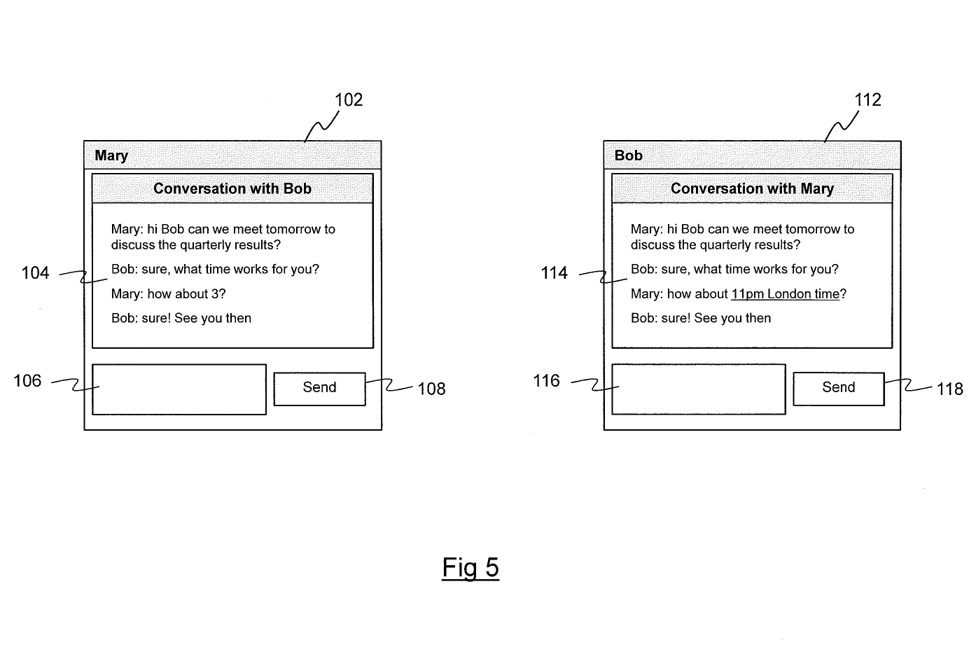

With reference to FIGS. 4 and 5 there is now described a process of processing a message for communication from the user terminal 204 (i.e. the sender user terminal) to the user terminal 212 (i.e. the recipient user terminal) according to a first embodiment. FIG. 5 shows the user interfaces 102 and 112 of the clients 208 and 214 which are displayed to the users 202 and 210 at the respective user terminals 204 and 212 when the method of FIG. 4 is implemented. The reference numerals in FIG. 5 correspond to those in FIG. 1 to denote corresponding elements.

In step S402, content of a message is received at the sender user terminal 204. For example, the user 202 (“Mary”) inputs text into the pane 106. In step S404 the client 208 processes the content in the pane 106 to form a message, and sends the message over the network 206 (e.g. in response to the user 202 clicking the send button 108 or pressing the enter key on the keyboard 306). In the first embodiment described in relation to the method shown in FIG. 4, the message is sent from the user terminal 204 to the server 216 of the communication system 200. The server 216 includes the necessary logic for implementing the processing of the message according to an embodiment of the invention. Step S404 may be initiated by the user 202 clicking on the button 108, e.g. using the mouse 308.

In step S406 the server 216 then determines whether the content of the message includes an indication of a time. In order to do this the server 216 may use logic to recognise numbers in the content of the message and determine that the numbers indicate a time in the sender's time zone. A person skilled in the art would be aware of methods which could be used to recognise an indication of a time in the content of the message. Any type of time recognition could be used to determine whether or not the content of the message includes an indication of a time in step S604.

If it is determined in step S406 that the content of the message sent from the user terminal 204 to the server 216 does not include an indication of a time then the method proceeds to step S408 in which the message is sent from the server 216 to the recipient user terminal 212. The message is then conveyed to the recipient (“Bob”) 210 at the user terminal 212 in step S410. Where the message is a text-based message, e.g. an instant message, then step S410 may comprise displaying the message to the user 210, e.g. in the pane 114 of the user interface 112 at the user terminal 212. However, if the message is a voice message then the step S410 of conveying the message to the user 210 may comprise playing the voice message to the user 210 e.g. using speakers of the user terminal 212.

However, if it is determined in step S406 that the content of the message sent from the user terminal 204 to the server 216 does include an indication of a time then the method proceeds to step S412 in which the server 216 determines the time zones of the sender 202 (Mary) and of the recipient 210 (Bob). The server 216 can determine the time zones of the users 202 and 210 at their respective user terminals 204 and 212 in a number of different ways. For example, the server 216 can determine the Internet Protocol (IP) address of the user terminals 204 and 212. From the IP addresses the server 216 can determine the location, and therefore the time zones, of the user terminals 204 and 212. Alternatively, when the clients 208 and 214 of the users 202 and 210 connect to the communication system 200 they can send a registration message to the server 216. The registration message may include an indication of the time zones of the user terminals 204 and 212 obtained from the operating systems of the respective user terminals 204 and 212. It can be assumed that the time zone of the user terminal 204 is the same as the time zone of the user 202 and likewise that the time zone of the user terminal 212 is the same as the time zone of the user 210.

Once the server 216 has determined the time zones of the sender 202 and the recipient 210, in step S414 the server 216 determines a corresponding time in the recipient's time zone which corresponds to the time indicated in the content of the message (as was found in step S406). In this sense the server 216 can translate the time indicated in the message into a corresponding time in the recipient's time zone. The time zones of the sender and the recipient (as determined in step S412) are used to determine how to translate the time in the message into a corresponding time in the recipient's time zone. The translated (or “corresponding”) time is included in the message.

In step S416 the server 216 transmits the message, including the translated time, to the recipient user terminal 212. The message is then conveyed to the recipient (“Bob”) 210 at the user terminal 212 in step S418 in much the same way as the message is conveyed in step S410 as described above. Where the message is a text-based message, e.g. an instant message, then step S418 may comprise displaying the message to the user 210, e.g. in the pane 114 of the user interface 112 at the user terminal 212. However, if the message is a voice message then the step S418 of conveying the message to the user 210 may comprise playing the voice message to the user 210 e.g. using speakers of the user terminal 212.

FIG. 5 shows what is displayed in the user interfaces 102 and 112 of the user terminals 204 and 212 when the method of FIG. 4 is used. It can be seen that the first two messages of the instant messaging communication are not altered as compared to the prior art system (shown in FIG. 1) because neither of the first two messages include an indication of a time. However, the third message, that is the message from Mary that says “how about 3?”, is treated differently according to the invention as compared to the prior art. The message includes an indication of a time (i.e. 3 o'clock). It is determined that Mary's time zone (e.g. that of California) is eight hours behind Bob's time zone (e.g. that of London). As such the message is altered when it is conveyed to Bob in the pane 114 of user interface 112, as shown in FIG. 5 to say “how about 11 pm London time?”. The time of 3 o'clock indicated in Mary's original message has been translated into 11 pm London time and it is this translated time which is displayed to the recipient user (Bob) at the user terminal 212. It is clear by comparing FIG. 5 with FIG. 1 that by translating the time into Bob's time zone, the meeting is arranged in much less time and with much less confusion.

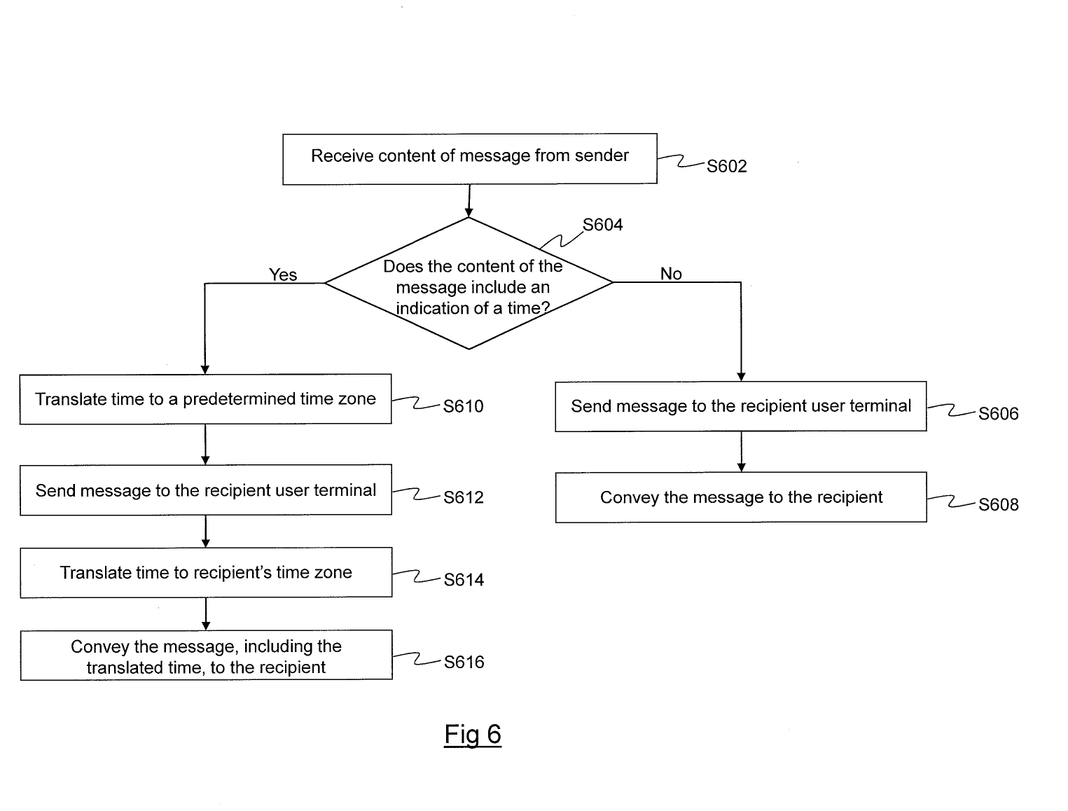

With reference to FIG. 6 there is now described a process of processing a message for communication from the user terminal 204 (i.e. the sender user terminal) to the user terminal 212 (i.e. the recipient user terminal) according to a second embodiment. The second embodiment has the same result as the first embodiment (described in relation to FIG. 4) in the sense that the messages displayed at the user terminals 204 and 212 will be those shown in FIG. 5, but the actual implementation of achieving the result shown in FIG. 5 is different in the second embodiment compared to the first embodiment. The second embodiment does not use the server 216 of the communication system. This allows the messages to be transmitted between the user terminals 204 and 212 over the network 206 using a point-to-point route, in a P2P manner.

In step S602 content of a message is received at the sender user terminal 204. For example, the user 202 (“Mary”) inputs text into the pane 106.

In step S604 it is determined at the user terminal 202 (in particular, by the client 208) whether the content of the message includes an indication of a time. In order to do this the client 208 may use logic to recognise numbers in the content of the message and determine that the numbers indicate a time in the sender's time zone. A person skilled in the art would be aware of methods which could be used to recognise an indication of a time in the content of the message. Any type of time recognition could be used to determine whether or not the content of the message includes an indication of a time in step S604.

If it is determined in step S604 that the content of the message received at the user terminal 204 from the user 202 does not include an indication of a time then the method proceeds to step S606 in which the message is sent from the user terminal 204 to the recipient user terminal 212 over the network 206 (e.g. using a point-to-point route). The message is then conveyed to the recipient (“Bob”) 210 at the user terminal 212 in step S608. Where the message is a text-based message, e.g. an instant message, then step S608 may comprise displaying the message to the user 210, e.g. in the pane 114 of the user interface 112 at the user terminal 212. However, if the message is a voice message then the step S608 of conveying the message to the user 210 may comprise playing the voice message to the user 210 e.g. using speakers of the user terminal 212.

However, if it is determined in step S604 that the content of the message received at the user terminal 204 from the user 202 does include an indication of a time then the method proceeds to step S610. In step S610 the client 208 translates the time indicated in the message into a corresponding time in a predetermined (or “global”) time zone, such as Greenwich Mean Time (GMT). The predetermined time zone is a time zone which both the sender and the recipient user terminals 204 and 212 have agreed to use. The user terminals 204 and 212 (in particular the clients 208 and 214) have the capability to convert times between their own time zones and the predetermined time zone. In order to do this the client 208 can determine the time zone of the user terminal 204, e.g. by obtaining this information from the operating system 314 of the user terminal 204. With knowledge of the time zone of the user terminal 204 and the knowledge of the predetermined time zone, the client 208 converts the time indicated in the message (as found in step S604) into a corresponding time in the predetermined time zone.

An indication of the corresponding time (or “standardised time”) in the predetermined time zone is included in the message, and in step S612 the message is sent to the recipient user terminal 212 over the network 206, e.g. using a point-to-point route through the network 206. The standardised time in the predetermined time zone may be marked as meta-data in the message. The message transmitted to the user terminal 212 may also include the original time that the user 202 entered in the message, e.g. as mark-up data.

The recipient user terminal 212 receives the message sent from the user terminal 204. The recipient user terminal 212 (in particular, the client 214) determines the time zone of the user terminal 212, e.g. by obtaining this information from an operating system of the user terminal 212. With knowledge of the time zone of the user terminal 212 and the knowledge of the predetermined time zone, in step S614 the client 208 converts the standardised time indicated in the message into a corresponding time in the recipient's time zone.

The corresponding time in the recipient's time zone is included in the message and in step S616 the message is then conveyed to the recipient (“Bob”) 210 at the user terminal 212. Where the message is a text-based message, e.g. an instant message, then step S616 may comprise displaying the message to the user 210, e.g. in the pane 114 of the user interface 112 at the user terminal 212. However, if the message is a voice message then the step S616 of conveying the message to the user 210 may comprise playing the voice message to the user 210 e.g. using speakers of the user terminal 212.

It can be seen that the method shown in FIG. 6 provides an implementation for allowing a conversation to flow, as shown in FIG. 5, whereby the third message (i.e. that sent from Mary to Bob saying “how about 3?”) is translated such that it is displayed to Bob in the user interface 114 as saying “how about 11 pm London time?”.

The embodiments described above apply automated processing to messages which recognizes numbers in the content of a message as indicating a time, determines the time zone of the sender, and converts the indicated time to the time zone of the recipient. The recipient receives the message, and the time in the time zone of the recipient (i.e. in the local time zone) is included in the message which is conveyed to the recipient.

In some embodiments, rather than displaying the translated time immediately in the message as the message is conveyed to the recipient as shown in FIG. 5, any number that is conceivably a time appears in its original form on the recipients screen. Then, when the recipient hovers their mouse over the number in the user interface, the number is shown to the recipient 210 at the user terminal 212 as a time in the time zone of the sender and then as a time in the time zone of the recipient.

In another embodiment, when the recipient receives the message, the time value is conveyed to the recipient in the local time of the recipient. The time value is highlighted or underlined (as shown in FIG. 5), and might also include an icon next to it, indicating that this value was automatically translated to the recipient's local time. When the recipient hovers their mouse over the time displayed in the user interface, the original text entered by the sender user is displayed to the recipient. This allows for errors in the translation of the time value. For example, if a number has mistakenly been identified as an indication of a time in the original message and has subsequently been translated before being conveyed to the recipient, then by allowing the recipient to see the original text entered by the sender, errors such as these can be handled.

Furthermore, in some embodiments, to make it clear to the sender 202 that the time that they entered into a message has been translated, when the sender 202 hits “enter” on the keyboard 306 or clicks the “send” button 108 to send a message to the recipient 210, the time value can be shown in the sender's user interface 102, in the local time zone of the sender. So in these embodiments, if Mary types “how about 3”, when she hits enter, her chat history in the pane 104 shows “how about 3 pm Pacific Time”, and underlines the “3 pm Pacific Time” part. The sender 202 can click on the underlined time in the chat history shown in pane 104 and the client 208 will then display to the sender 202 the text that she originally typed into the pane 106. This allows Mary to correct the message if the translation of the time was done improperly, e.g. if the number was not supposed to be an indication of a time.

The methods and systems described herein improve upon the prior art system shown in FIG. 1 by actually translating time values in message (e.g. chat or email) content to the local time of the participant. This can be used to facilitate the organisation of meetings.

It can be seen in the example shown in FIG. 5 that when the time is translated into the corresponding time in the recipient's time zone, it can be conveyed to the recipient 210 with an indication of the recipient's time zone (e.g. “11 pm London time”). The formatting of the translated time can be different to the rest of the content of the message, for example the indication “11 pm London time” can be underlined, highlighted or emboldened, or written in italics or a different font or size or colour, or any other type of formatting that can distinguish the translated time from the rest of the content of the message may be used. This lets the recipient know that the time has been translated. The recipient can then decide, if he so wishes, to check what the original message said (e.g. by hovering over the indication of the time in the recipient's time zone, as described above) in order to check that the translation of the time from the sender's time zone to the recipient's time zone did not contain errors. This can be useful if it is clear to the recipient that the number that has been translated was not in fact indicating a time in the sender's time zone, such that the translation of the time will not be correct. Indeed the number that has been translated may not indicate a time at all.

In the preferred embodiments described above there are just two participants in the communication, such that each message has one sender and one recipient. However, in other embodiments, there could be more than two participants in a communication, and a message could have more than one recipient, which may or may not be in different time zones. The time indicated in the original message may be translated into different corresponding times to be conveyed to the respective recipients in the different time zones. This allows the sender to send the same message to multiple recipients, and a time in the message can be translated into a respective time zone for each of the recipients.

In the preferred embodiments described above, the content of the message is text, and the indication of the time is a text indication. However, in other embodiments, the message may include content other than text, such as voice or multimedia. The indication of the time may accordingly be a voice indication. In this case voice recognition methods could be used to determine that the content of the message includes an indication of a time and then the time can be translated to a corresponding time for the recipients. The corresponding time can be included in the voice message, e.g. using automated, recorded, voice signals. In this way, even where the message is a voice message, the indication of a time in the original message can be translated into a corresponding time in the recipient's time zone.

The method steps shown in FIGS. 4 and 6, and described above, may be implemented in software or hardware as appropriate. This is an implementation choice to suit particular embodiments. Furthermore, there may be provided computer program products comprising computer readable instructions for execution by computer processing means at the sender user terminal 204, the recipient user terminal 212 and the server 216, wherein the instructions comprise instructions for carrying out the methods described above.

Furthermore, while this invention has been particularly shown and described with reference to preferred embodiments, it will be understood to those skilled in the art that various changes in form and detail may be made without departing from the scope of the invention as defined by the appendant claims.

1. A method of processing a message for communication from a sender user terminal of a sender in a first time zone to a recipient user terminal of a recipient in a second time zone, the method comprising:
receiving, at the sender user terminal from the sender, content of the message;
determining that the content includes an indication of a time in the first time zone;
sending the message over a network from the sender user terminal to the recipient user terminal;
determining a corresponding time in the second time zone which corresponds to the time in the first time zone indicated by the indication; and
conveying the message to the recipient at the recipient user terminal, the conveyed message including a second indication which indicates the determined corresponding time in the second time zone.

2. The method of claim 1 wherein the content comprises text.

3. The method of claim 2 wherein the message is an email message or an instant message.

4. The method of claim 1 wherein the content comprises voice data.

5. The method of claim 1 wherein the conveyed message includes the indication of the time in the first time zone.

6. The method of claim 1 wherein the time indicated by the indication is a time for an event in which the sender and the recipient are to simultaneously participate.

7. The method of claim 1 wherein said determining a corresponding time in the second time zone comprises:
determining the first time zone of the sender;
determining the second time zone of the recipient; and
using the determined first and second time zones and the indication of the time in the first time zone to determine the corresponding time in the second time zone.

8. The method of claim 7 wherein the step of sending the message over a network from the sender user terminal to the recipient user terminal comprises sending the message via a server, and wherein the step of determining a corresponding time in the second time zone is performed by the server.

9. The method of claim 1 wherein said determining a corresponding time in the second time zone comprises:
determining the first time zone of the sender;
using the determined first time zone to determine a standardised time in a predetermined time zone which corresponds to the time in the first time zone indicated by the indication;
determining the second time zone of the recipient; and
using the determined second time zone and the determined standardised time in the predetermined time zone to determine the corresponding time in the second time zone.

10. The method of claim 9 wherein the steps of determining the first time zone and using the determined first time zone to determine a standardised time are performed at the sender user terminal, and wherein the steps of determining the second time zone using the determined second time zone and the determined standardised time in the predetermined time zone to determine the corresponding time are performed at the recipient user terminal.

11. The method of claim 10 wherein the step of sending the message over a network from the sender user terminal to the recipient user terminal comprises sending the message over a point-to-point route between the sender user terminal and the recipient user terminal.

12. The method of claim 1 wherein there are a plurality of recipient user terminals of a respective plurality of recipients of the message.

13. A communication system comprising a sender user terminal of a sender in a first time zone and a recipient user terminal of a recipient in a second time zone, the communication system comprising:
a receiver configured to receive, at the sender user terminal from the sender, content of a message;
a content determining module configured to determine that the content includes an indication of a time in the first time zone;
a sending module configured to send the message over a network from the sender user terminal to the recipient user terminal;
at least one time determining module configured to determine a corresponding time in the second time zone which corresponds to the time in the first time zone indicated by the indication; and
a conveying module configured to convey the message to the recipient at the recipient user terminal, the conveyed message including a second indication which indicates the determined corresponding time in the second time zone.

14. The communication system of claim 13 further comprising a server, wherein the message is sent from the sender user terminal to the recipient user terminal via the server.

15. The communication system of claim 14 wherein the receiver and the content determining module are implemented at the sender user terminal, wherein the at least one time determining module is implemented at the server and wherein the conveying module is implemented at the recipient user terminal.

16. The communication system of claim 13 wherein the receiver and the content determining module are implemented at the sender user terminal, wherein the conveying module is implemented at the recipient user terminal, and wherein the at least one time determining module comprises a first time determining module implemented at the sender user terminal and second time determining module implemented at the recipient user terminal.

17. A method of sending a message over a network from a sender user terminal of a sender in a first time zone to a recipient user terminal of a recipient in a second time zone, the method comprising:
receiving, at the sender user terminal from the sender, content of the message;
determining, at the sender user terminal, that the content includes an indication of a time in the first time zone;
determining, at the sender user terminal, the first time zone of the sender;
determining, at the sender user terminal, a standardised time in a predetermined time zone which corresponds to the time in the first time zone indicated by the indication;
including the standardised time in the message; and
sending the message over the network from the sender user terminal to the recipient user terminal,
such that by using the standardised time in the message and the second time zone the recipient user terminal can determine a corresponding time in the second time zone which corresponds to the time in the first time zone indicated by the indication.

18. A computer program product comprising computer readable instructions stored on a non-transitory computer useable medium for execution by computer processor at a sender user terminal of a sender in a first time zone for sending a message over a network from the sender user terminal to a recipient user terminal of a recipient in a second time zone, the instructions comprising instructions for:
receiving, at the sender user terminal from the sender, content of the message;
determining, at the sender user terminal, that the content includes an indication of a time in the first time zone;
determining, at the sender user terminal, the first time zone of the sender;
determining, at the sender user terminal, a standardised time in a predetermined time zone which corresponds to the time in the first time zone indicated by the indication;
including the standardised time in the message; and
sending the message over the network from the sender user terminal to the recipient user terminal,
such that by using the standardised time in the message and the second time zone the recipient user terminal can determine a corresponding time in the second time zone which corresponds to the time in the first time zone indicated by the indication.

19. A sender user terminal of a sender in a first time zone for sending a message over a network to a recipient user terminal of a recipient in a second time zone, the sender user terminal comprising:
a receiver configured to receive, from the sender, content of the message;
a content determining module configured to determine that the content includes an indication of a time in the first time zone;
a first time zone determining module configured to determine the first time zone of the sender;
a standardised time determining module configured to determine a standardised time in a predetermined time zone which corresponds to the time in the first time zone indicated by the indication;
a processing module configured to include the standardised time in the message; and
a sending module configured to send the message over the network to the recipient user terminal,
such that by using the standardised time in the message and the second time zone the recipient user terminal can determine a corresponding time in the second time zone which corresponds to the time in the first time zone indicated by the indication.

20. A method of processing a message received, from a sender user terminal of a sender in a first time zone, at a recipient user terminal of a recipient in a second time zone, the method comprising:
receiving a message at the recipient user terminal over a network from the sender user terminal, the message comprising a standardised time in a predetermined time zone;
determining, at the recipient user terminal, the second time zone of the recipient;
using the determined second time zone and the standardised time in the predetermined time zone to determine, at the recipient user terminal, a corresponding time in the second time zone which corresponds to the standardised time in the predetermined time zone; and
conveying the message to the recipient at the recipient user terminal, the conveyed message including an indication which indicates the determined corresponding time in the second time zone.

21. A computer program product comprising computer readable instructions stored on a non-transitory computer useable medium for execution by a computer processor at a recipient user terminal for processing a message received from a sender user terminal of a sender in a first time zone, the recipient user terminal being of a recipient in a second time zone, the instructions comprising instructions for:
receiving a message at the recipient user terminal over a network from the sender user terminal, the message comprising a standardised time in a predetermined time zone;
determining, at the recipient user terminal, the second time zone of the recipient;
using the determined second time zone and the standardised time in the predetermined time zone to determine, at the recipient user terminal, a corresponding time in the second time zone which corresponds to the standardised time in the predetermined time zone; and
conveying the message to the recipient at the recipient user terminal, the conveyed message including an indication which indicates the determined corresponding time in the second time zone.

22. A recipient user terminal for processing a message received from a sender user terminal of a sender in a first time zone, the recipient user terminal being of a recipient in a second time zone, the recipient user terminal comprising:
a receiver configured to receive a message over a network from the sender user terminal, the message comprising a standardised time in a predetermined time zone;
a time zone determining module configured to determine the second time zone of the recipient;
a time determining module configured to determine a corresponding time using the determined second time zone and the standardised time in the predetermined time zone, the corresponding time being a time in the second time zone which corresponds to the standardised time in the predetermined time zone; and
a conveying module configured to convey the message to the recipient at the recipient user terminal, the conveyed message including an indication which indicates the determined corresponding time in the second time zone.

23. A method of processing a message at a server, the message being for communication from a sender user terminal of a sender in a first time zone to a recipient user terminal of a recipient in a second time zone, the method comprising:
receiving the message at the server from the sender user terminal over a network;
determining, at the server, that the content of the message includes an indication of a time in the first time zone;
determining, at the server, a corresponding time in the second time zone which corresponds to the time in the first time zone indicated by the indication; and
transmitting the message from the server to the recipient user terminal over the network, the transmitted message including a second indication which indicates the determined corresponding time in the second time zone.

24. A computer program product comprising computer readable instructions stored on a non-transitory computer useable medium for execution by a computer processor at a server for processing a message, the message being for communication from a sender user terminal of a sender in a first time zone to a recipient user terminal of a recipient in a second time zone, the instructions comprising instructions for:
receiving the message at the server from the sender user terminal over a network;
determining, at the server, that the content of the message includes an indication of a time in the first time zone;
determining, at the server, a corresponding time in the second time zone which corresponds to the time in the first time zone indicated by the indication; and
transmitting the message from the server to the recipient user terminal over the network, the transmitted message including a second indication which indicates the determined corresponding time in the second time zone.

25. A server for processing a message, the message being for communication from a sender user terminal of a sender in a first time zone to a recipient user terminal of a recipient in a second time zone, the server comprising:
a receiver configured to receive the message from the sender user terminal over a network;
a content determining module configured to determine that the content of the message includes an indication of a time in the first time zone;
a time determining module configured to determine a corresponding time in the second time zone which corresponds to the time in the first time zone indicated by the indication; and
a transmitter configured to transmit the message to the recipient user terminal over the network, the transmitted message including a second indication which indicates the determined corresponding time in the second time zone.
